(19) United States
(12) Patent Application Publication
(10) Pub. No.: US 2011/0253395 A1
(43) Pub. Date: Oct. 20, 2011

(54) Non-Differential Dry Pipe Valve and Fire Suppression System and Method Thereof

(76) Inventor: Robert A. Long, Clarkston, MI (US)

(21) Appl. No.: 12/908,412

(22) Filed: Oct. 20, 2010

Related U.S. Application Data
(63) Continuation-in-part of application No. 12/518,933, filed on Jun. 12, 2009.
(60) Provisional application No. 60/875,049, filed on Dec. 15, 2006.
(60) Provisional application No. 61/303,099, filed on Feb. 10, 2010.
(60) Provisional application No. 61/253,301, filed on Oct. 20, 2009.

(51) Int. Cl. A62C 35/00

(52) U.S. Cl. 169/17; 169/16

(57) ABSTRACT

A non-differential dry pipe valve and fire suppression system are provided. The fire suppression system includes at least one inlet pipe, at least one outlet pipe, and a first valve assembly. The inlet pipe is at least partially filled with a fluid substance, wherein the fluid substance creates a first pressure in the inlet pipe. The outlet pipe is in fluid communication with the inlet pipe and contains a gaseous fluid, wherein the gaseous fluid creates a second pressure in the outlet pipe. The first valve assembly is in fluid communication between the inlet pipe and the outlet pipe, wherein the fluid substance enters the outlet pipe through the valve when the second pressure is altered to a predetermined pressure.

### CROSS-REFERENCE TO RELATED APPLICATION

This application is a continuation-in-part of U.S. patent application Ser. No. 12/518,933, filed on Jun. 12, 2009, which claims priority to PCT/US2007/087516, filed on Dec. 14, 2007, which claims priority to U.S. Provisional Patent Application No. 60/875,049, filed on Dec. 15, 2006; and also claims the benefit under 35 U.S.C. §119(e) of U.S. Provisional Patent Application No. 61/303,099, filed on Feb. 10, 2010, by Robert Long, and U.S. Provisional Patent Application No. 61/253,301, filed on Oct. 20, 2009, by Robert Long, the entire disclosures of which are hereby incorporated herein by reference.

### FIELD OF THE INVENTION

The present invention relates to a fire suppression system, and more particularly, to a fire suppression system having at least one dry pipe valve.

### BACKGROUND OF THE INVENTION

Due to modern building codes, buildings above a predetermined size, based upon square footage, are generally required to have fire suppression systems. Generally, it may be beneficial to have a fire suppression system in any dwelling without regard to the size of the dwelling. However, due to climates where freezing temperatures are reached, fire suppression systems can generally be designed so that the water being held in portions of the system does not freeze. Typically, if the water in the fire suppression system does freeze, the fire suppression system can be rendered inoperable and/or cause damage to the fire suppression system. More specifically, the piping in the system can be damaged. Generally, environments having excessive temperatures that cause the water in the pipes to boil or climates with extreme temperature fluctuations can have adverse effects on pipes and/or piping components of the fire suppression system due to thermal expansion and contortion.

One exemplary system designed to prevent a fluid within the system from freezing is a system wherein the pipes of the fire suppression system are filled with glycol. Generally, glycol has a low freezing temperature when compared to the freezing temperature of water, which allows it to withstand cold ambient temperatures without freezing. However, the glycol systems typically require constant maintenance, which can be an expensive process. Additionally, glycol systems are generally undesirable, especially for residential dwellings, due to the chemical agent being constantly present in the fire suppression system piping that extends throughout the dwelling.

When a fire suppression system uses glycol or a similar chemical agent, the system typically includes a check valve that separates the glycol and the water. The check valve generally only allows fluids to flow one way, such that the glycol is prevented from entering the area of the system occupied by water. Thus, once the glycol is removed from the system, the check valve typically allows the water to flow into the area of the system where the glycol was previously present. Generally, the glycol exits the system when a sprinkler head is opened, and the glycol is discharged over an area surrounding the sprinkler head prior to the sprinkler head discharging water over the surrounding area. Further, the fire suppression system using a check valve generally requires a second fluid, such as the glycol, to be in a portion of the system, otherwise water would pass through the check valve at undesirable times, which creates a potential for the water to freeze and damage the system.

Additionally, in any fire suppression system where there is a fluid material in the system, there is generally a possibility of the fluid exiting the system at undesirable times. For example, the fluid material can leak from the fire suppression system and cause damage to item or objects around the system, such as furniture in a residential dwelling or inventory in a commercial or industrial dwelling.

### SUMMARY OF THE INVENTION

According to one aspect of the present invention, a fire suppression system includes at least one inlet pipe, at least one outlet pipe, and a first valve assembly. The at least one inlet pipe is at least partially filled with a fluid substance, wherein the fluid substance creates a first pressure in the at least one inlet pipe. The at least one outlet pipe is in fluid communication with the at least one inlet pipe and contains a gaseous fluid, wherein the gaseous fluid creates a second pressure in the at least one outlet pipe. The first valve assembly is in fluid communication between the at least one inlet pipe and the at least one outlet pipe, wherein the fluid substance enters the at least one outlet pipe through the valve when the second pressure is altered to a predetermined pressure.

According to another aspect of the present invention, a fire suppression system includes at least one inlet pipe, at least one outlet pipe, and a first non-differential dry valve assembly. The at least one inlet pipe is at least partially filled with a fluid substance, wherein the fluid substance creates a first pressure in the at least one inlet pipe. The at least one outlet pipe is in fluid communication with the at least one inlet pipe and contains a gaseous fluid, wherein the gaseous fluid creates a second pressure in the at least one outlet pipe, and the at least one outlet pipe defines at least one opening. The valve assembly is a first non-differential dry valve assembly that is in fluid communication between the at least one inlet pipe and the at least one outlet pipe, wherein the fluid substance enters the at least one outlet pipe through the first non-differential dry valve assembly when the second pressure is altered to a predetermined pressure, and the fluid substance exits the at least one outlet pipe through the at least one opening.

According to yet another aspect of the present invention, a non-differential dry pipe valve configured for use in a fire suppression system includes an inlet at least partially filled with a fluid substance, wherein the fluid substance creates a first pressure, an outlet in fluid communication with the inlet, wherein the outlet is filled with a gaseous fluid, a valve in fluid communication between the inlet and the outlet, and an actuator in operable communication with the valve, wherein the actuator is configured to open and close the valve. The non-differential dry pipe valve further includes a pressure regulator in fluid communication between the inlet and the outlet, wherein the pressure regulator is configured to reduce a pressure of the fluid flowing from the inlet to the outlet, and a restricting valve in fluid communication between the pressure regulator and the outlet, wherein the restricting valve is configured to prevent flow of the fluid from the outlet to the inlet, such that the fluid flowing from the inlet to the outlet through the pressure regulator and the restricting valve create a second pressure to alter the actuator to place the valve in a closed position independent of a pressure of the gaseous fluid in the outlet.

These and other features, advantages, and objects of the present invention will be further understood and appreciated by those skilled in the art by reference to the following specification, claims, and appended drawings.

### BRIEF DESCRIPTION OF THE DRAWINGS

The present invention will become more fully understood from the detailed description and the accompanying drawings, wherein:

FIG. 1 is a schematic plan view of a fire suppression system, in accordance with one embodiment of the present invention;

FIG. 2 is a schematic plan view of a fire suppression system, in accordance with one embodiment of the present invention;

FIG. 3 is a schematic plan view of a fire suppression system, in accordance with an alternate embodiment of the present invention;

FIG. 4 is a perspective cross-sectional view of a valve assembly in a fire suppression system, in accordance with one embodiment of the present invention;

FIG. 5 is an environmental view of a fire suppression system, in accordance with one embodiment of the present invention;

FIG. 6 is a flow chart illustrating a method of suppressing a fire, in accordance with one embodiment of the present invention;

FIG. 7 is an environmental view of a fire suppression system having a wet pipe portion separated from a dry pipe portion by a valve assembly, in accordance with one embodiment of the present invention;

FIG. 8 is an environmental view of a fire suppression system having a wet pipe portion separated from a dry pipe portion by a valve assembly, in accordance with one embodiment of the present invention;

FIG. 9 is an environmental view of a zoned fire suppression system, in accordance with one embodiment of the present invention; and

FIG. 10 is a schematic diagram of a valve assembly, in accordance with one embodiment of the present invention.

### DETAILED DESCRIPTION OF PREFERRED EMBODIMENTS

The present illustrated embodiments reside primarily in combinations of method steps and apparatus components related to a fire suppression system and method thereof. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein. Further, like numerals in the description and drawings represent like elements.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

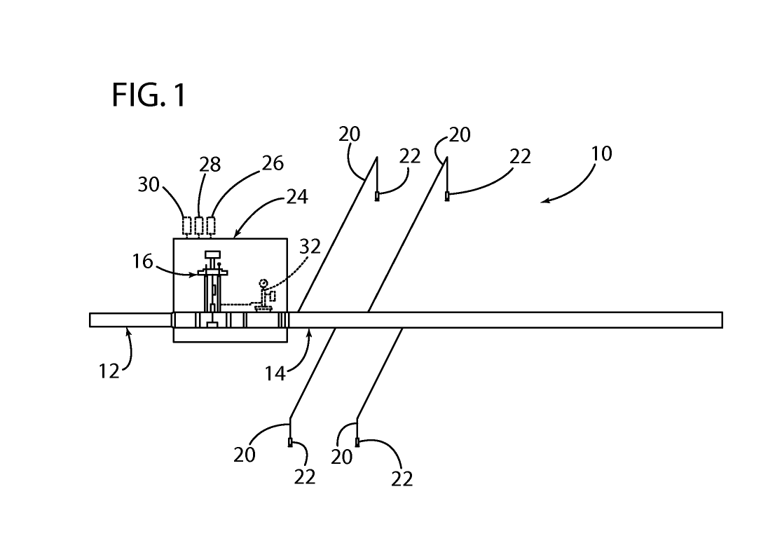

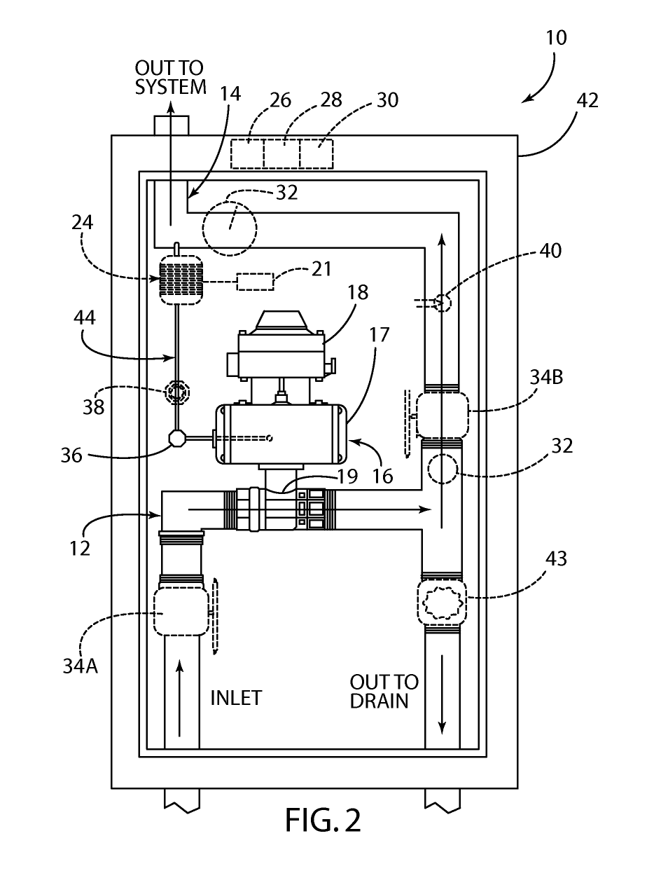

In reference to FIGS. 1 and 2, a fire suppression system is generally shown at reference identifier 10. The fire suppression system 10 (FIGS. 1-2) has at least one inlet pipe generally indicated at 12 and at least one outlet pipe generally indicated at 14. The inlet pipe 12 and outlet pipe 14 are in fluid communication with one another, and a valve assembly, generally indicated at 16, is in fluid communication between the inlet pipe 12 and outlet pipe 14. Thus, the fluid communication among components generally allows a fluid substance to flow through components, to components from other components that are directly or indirectly connected, or a combination thereof. A fluid substance in the inlet pipe 12 creates a first pressure in the inlet pipe 12, and a gaseous fluid contained in the outlet pipe 14 creates a second pressure in the outlet pipe 14. The fire suppression system 10 can be a pneumatic fire suppression system or a vacuum fire suppression system due to the gaseous fluid contained in the outlet pipe 14, wherein the valve assembly 16 is actuated based upon an alteration of the second pressure, as described in greater detail herein.

According to one embodiment, the inlet pipe 12 is connected to one portion of the valve assembly 16, and is filled with the fluid substance that is used to extinguish a fire, such as, but not limited to water. Thus, the fluid substance creates the first pressure in the inlet pipe 12. The outlet pipe 14 is connected to another portion of the valve assembly 16 and is filled, such that the outlet pipe 14 is precharged, with a gaseous fluid, such as, but not limited to, compressed air, according to one embodiment. Thus, the compressed air contained in the outlet pipe 14 creates the second pressure when the fire suppression system 10 is a pneumatic system. According to an alternate embodiment, the outlet pipe 14 contains the gaseous fluid, such that at least a portion of the gaseous fluid is removed from said outlet pipe 14 to substantially create a vacuum, which creates the second pressure in the outlet pipe 14 when the fire suppression system 10 is a vacuum system.

The fire suppression system 10 is a dry pipe fire suppression system, according to one embodiment. The inlet pipe 12 can be referred to as the wet or active side and the outlet pipe 14 can be referred to as the dry or passive side. Generally, the wet side can be referred to as the active side because this side of the fire suppression system 10 is generally at least partially filled with the fluid substance when the fire suppression system 10 is functioning, and the valve assembly 16 is closed. The dry side can be referred to as the passive side because this side is properly charged with compressed air or is substantially a vacuum and reacts to other components of the fire suppression system 10, as described in greater detail below.

By way of explanation and not limitation, the valve assembly 16 is an air-to-close valve and is designed to use the second pressure from the outlet pipe 14 to remain in a closed position so that the fluid from the inlet pipe 12 does not enter the outlet pipe 14 at undesirable times. Thus, the valve assembly 16 can be an actuated valve assembly, such as a direct-acting actuated dry valve assembly, according to one embodiment.

The valve assembly 16 can include an actuator 17 and a limit switch 18, wherein the actuator 17 is actuated to open and close a valve 19 based upon the second pressure, according to one embodiment. For purposes of explanation and not limitation, the valve 19 can be, but is not limited to, a ball valve, a butterfly valve, or the like. When the valve 19 is in a fully closed position, the valve 19 is located to at least substantially block the flow of the fluid substance from the inlet pipe 12 to the outlet pipe 14, and when the valve 19 is in an open position, the valve 19 is positioned to allow flow of the fluid substance between the inlet pipe 12 and the outlet pipe 14. Typically, the limit switch 18 is in operable communication with the valve 19, such that when the valve 19 actuates, the limit switch 18 rotates, and a user can determine the location of the valve 19 by the rotational location of the limit switch 18. According to one embodiment, the valve assembly 16 includes a VALTORC™ actuator, a VALTORC™ limit switch, and a VALTORC™ ball valve.

According to one embodiment, the outlet pipe 14 has a single connection with the valve assembly 16, and has at least one branch 20 that extends from the outlet pipe 14. Typically, the outlet pipe 14, the branch 20, or a combination thereof, define at least one opening, wherein the gaseous fluid enters or exits the outlet pipe 14 through the at least one opening to alter the second pressure. The fluid substance then exits the outlet pipe 14 through the at least one opening. According to one embodiment, the opening is at least one sprinkler head 22 that is connected to an end of the branch 20. Generally, the sprinkler head 22 is altered to form the opening, as described in greater detail below. It should be appreciated by those skilled in the art that that the sprinkler head 22 can be connected to other portions of the branch 20, the outlet pipe 14, or a combination thereof. Additionally or alternatively, the outlet pipe 14 can be a leak free pipe, such as, but not limited to, welded piping, such as Fusiotherm piping, metallic piping, such as copper piping, solder piping, or brazed piping, or non-metallic piping, such as polyvinyl chloride (PVC), the like, or a combination thereof, according to one embodiment.

An alarm system, generally indicated at 24, can be operably connected to the inlet pipe 12, the outlet pipe 14, valve assembly 16, or a combination thereof, according to one embodiment. The alarm 24 can have three settings, wherein the first setting 26 can be a green light, which indicates that the fire suppression system 10 is operating under normal conditions. The second setting 28 can be a yellow light, which indicates that the first pressure in the inlet pipe 12, the second pressure in the outlet pipe 14, or a combination thereof is below a predetermined level. The third setting 30 can be a red light that indicates there is flow or activation in the fire suppression system 10, such as the fluid substance of the inlet pipe 12 has entered the outlet pipe 14, a pressure loss less than that required to maintain closer of valve 19, or a combination thereof. It should be appreciated by those skilled in the art that the alarm system 24 can have additional or less settings depending on how many pressure levels it is desirable to monitor. Additionally, the fire suppression system 10 can include a battery 21 that is electrically connected to one or more components of the fire suppression system 10, such as, but not limited to, an alarm 24, according to one embodiment.

According to one embodiment, a pressure sensor or gauge 32 can be placed on the outlet pipe 14. The pressure gauge 32 is used to determine the pressure in the outlet pipe 14 at any given time. One exemplary pressure gauge 32 is an Ashcroft pressure gauge. However, it should be appreciated by those skilled in the art that the pressure gauge 32 can be an electronic pressure sensor or other types of suitable pressure gauges. Additionally or alternatively, at least one control valve is in operable communication with the inlet pipe 12 and the outlet pipe 14, so that portions of the inlet pipe 12 or outlet pipe 14 can be separated from one another. According to one embodiment, a first control valve 34A is in operable communication with the inlet pipe 12, and a second control valve 34B is in operable communication with the outlet pipe 14.

A valve 36 is in operable communication with the outlet pipe 14 and the valve assembly 16. According to one embodiment, charged air is entered into the outlet pipe 14 through the valve 36 in order to increase the air pressure of the outlet pipe 14. According to an alternate embodiment, the valve 36 is used to remove air from the outlet pipe 14 to create a vacuum. For purposes of explanation and not limitation, the valve 36 can be a Schraeder valve. Additionally or alternatively, a tee 38 and a transducer 40 can be in operable communication in the outlet pipe 14. The transducer 40 can be a two-point or eight-point transducer to monitor the second pressure of the outlet pipe 14, according to one embodiment. Additionally, the transducer 40 can be operably connected to a dialer, or other communication device, so that a signal can be transmitted to a third party when either or both of the first and second pressures are at predetermined pressure levels, the valve assembly 16 is open and the fluid substance is entering the outlet pipe 14, the like, or a combination thereof, according to one embodiment. The dialer can communicate through, but not limited to, telephone lines, data lines, wireless communication, or the like.

Further, a portion of the inlet pipe 12, a portion of the outlet pipe 14, and the valve assembly 16 can be enclosed within a housing 42, such that the housing 42 has three openings for the inlet pipe 12, the outlet pipe 14 going to the branches 22, and the outlet pipe 14 going to a drain, according to one embodiment. Thus, the portion of the fire suppression system 10 that is within the housing 42 can be considered a single unit, wherein the unit can be connected in the fire suppression system 10 by the three piping connections, according to one embodiment.

In reference to FIG. 2, the control valve 34A is in fluid communication with the inlet pipe 12, the control valve 34B is in fluid communication with the portion of the outlet pipe 14 that directs flow to the branches 22, and a gate valve 43 is in fluid communication with the portion of the outlet pipe 14 that directs flow to the drain. Additionally, the pressure gauge 32 and transducer 40 are on opposite sides of the control valve 34B, and a second pressure gauge 32 can be downstream of the transducer 40, according to one embodiment.

According to one embodiment, a feedback generally indicated at 44 feeds a portion of the gaseous fluid from the outlet pipe 14 back to the valve assembly 16. According to one embodiment, the alarm 24, tee 38, and valve 36 are in fluid communication with the feedback 44. Typically, the feedback 44 provides a pressure, such as the second pressure, to the valve assembly 16, so that the valve assembly 16 can actuate as a function of the provided pressure. Thus, the feedback 44 can connect the actuator 17 and the outlet pipe 14, so that the actuator 17 and outlet pipe 14 are in fluid communication, and the actuator 17 actuates as a function of the provided pressure, according to one embodiment. Additionally or alternatively, a pressure regulating valve, a pressure reducing valve, or a combination thereof can be in operable communication with feedback 44 to control the second pressure in the outlet pipe 14, the pressure provided to the valve assembly 16, or a combination thereof.

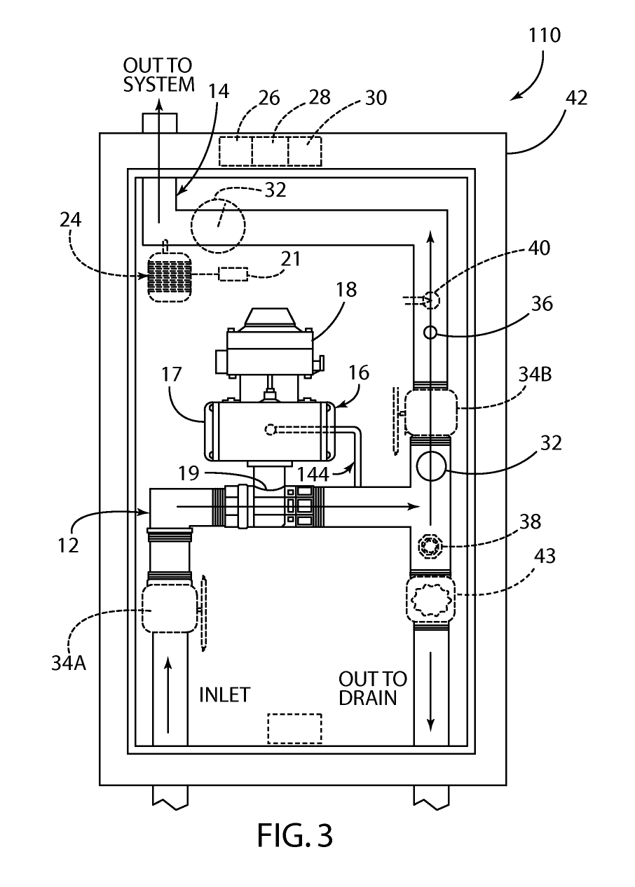

According to an embodiment shown in FIG. 3, a fire suppression system is generally shown at reference identifier 110. The fire suppression system 110 includes the inlet pipe 12, the outlet pipe 14, and the valve assembly 16. Additionally, the fire suppression system 110 can include the alarm system 24, the pressure gauge 32, the inlet control valve 34A, the outlet control valve 34B, the valve 36, the tee 38, the transducer 40, the housing 42, the gate valve 43, or a combination thereof, according to one embodiment. Further, the fire suppression system 110 includes a feedback 144 that connects a portion of the outlet pipe 14 to the actuator 17, such that a pressure is provided to the actuator 17 from the outlet pipe 14, according to one embodiment. Thus, the actuator 17 can actuate as a function of the provided pressure.

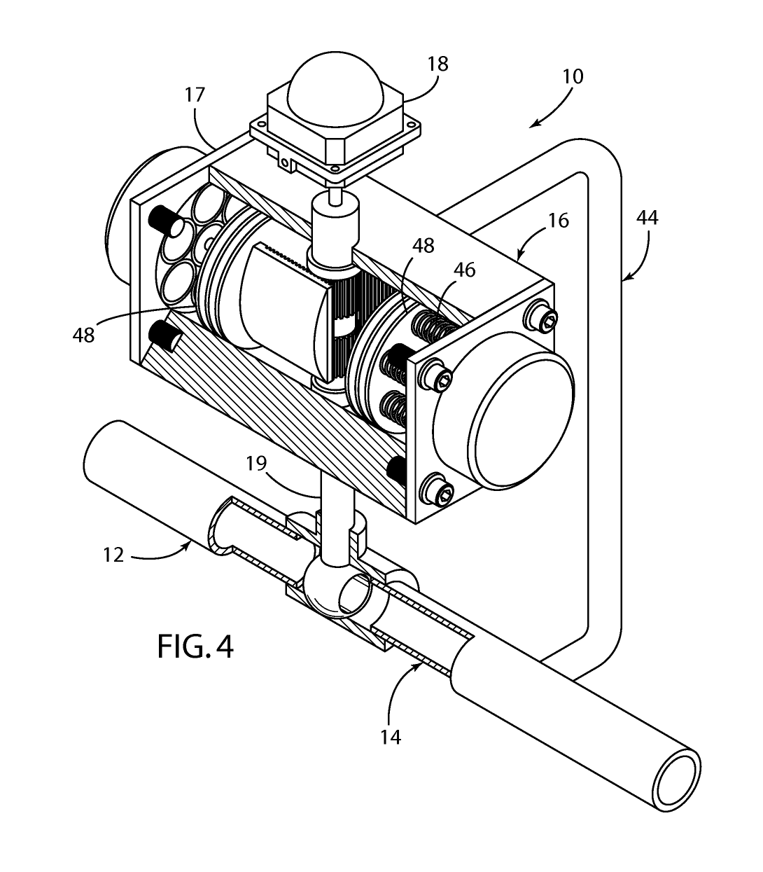

In reference to FIG. 4, the actuator 17 includes at least one spring 46 having a tension and at least one piston 48 biased by the at least one spring 46. According to one embodiment, when the fire suppression system 10,110 is a pneumatic fire suppression system, such that the pressurized gaseous fluid is contained in the outlet pipe 14, the gaseous fluid pressure fed back to the actuator 17 from the outlet pipe 14 through the feedback 44,144 is adequate to overcome the tension of the spring 46 in order to bias the piston 48 in a closed position. Thus, when the pressure of the gaseous fluid in the outlet pipe 14 (i.e., the second pressure) is below a predetermined level, the second pressure is inadequate to overcome the tension of the spring 46, and the spring 46 biases the piston 48 in an open position, according to one embodiment. Thus, piston 48 “fails open” when the second pressure is at or below a predetermined value, such that the gaseous fluid exits the outlet pipe 14 and the fluid substance passes through the valve assembly 16 into the outlet pipe 14 and exits the outlet pipe 14.

When the fire suppression system 10,110 is a vacuum system, the outlet pipe 14 contains a gaseous fluid in order to create a vacuum, and the pressure created in the outlet pipe 14 is fed back to the actuator 17 through the feedback 44,144, such that the pressure is inadequate to overcome the spring 46 tension, so that the spring 46 biases the piston 48 in a closed position. As an opening is formed in the outlet pipe 14, and the gaseous fluid enters the outlet pipe 14, which increases the second pressure, the pressure supplied from the outlet pipe 14 to the actuator 17 through the feedback 44,144 is adequate to overcome the spring 46 tension and the spring 46 biases the piston 48 in an open position. Thus, the valve 19 opens in order to allow the fluid substance from the inlet pipe 12 to flow through the valve assembly 16 and into the outlet pipe 14, and the fluid substance exits the outlet pipe 14 through the opening.

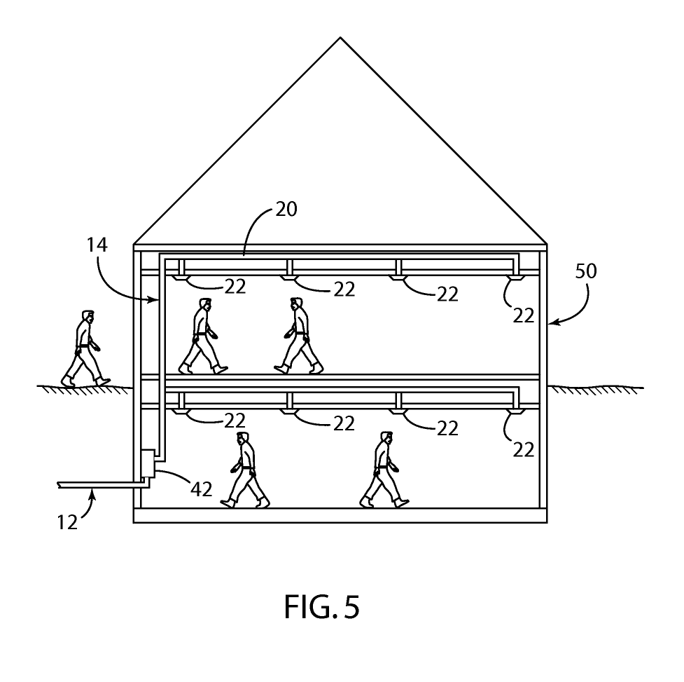

For purposes of explanation and not limitation, in reference to FIGS. 1-5 and in operation, the fire suppression system 10,110 is used in a dwelling generally indicated at 50 in FIG. 5. The dwelling 50 can be, but is not limited to, a domestic or residential dwelling. The inlet pipe 12 enters the dwelling 50, and is filled with the fluid substance, such as water, from the domestic water line. The valve assembly 16 then connects and separates the inlet pipe 12 and outlet pipe 14. Typically, the valve assembly 16 is connected to the inlet pipe 12 relatively close to the point of entrance of the inlet pipe 12 into the dwelling 50; thus, limiting the amount of pipes 12, 14, 20 filled with the fluid substance that extend throughout the dwelling 50. The outlet pipe 14 and branches 20 extend throughout the dwelling 50. However, it should be appreciated by those skilled in the art that the valve assembly 16 can be placed any where in the dry pipe fire suppression system 10, such that the dry or passive portion of the system 10 is only a specific zone(s), or as an extension of an existing wet pipe fire suppression system. It should further be appreciated by those skilled in the art that the fire suppression system 10 can be used in other dwellings, such as, but not limited to, industrial dwellings and commercial dwellings.

Typically, the first pressure created by the fluid in the inlet pipe 12 is about 80 psi (pounds per square inch), according to one embodiment. However, it should be appreciated by those skilled in the art that the first pressure can be any pressure level, and can be dependent upon the fluid substance system that provides the fluid substance to the inlet pipe 14. When the fire suppression system 10,110 is a pneumatic fire suppression system, the outlet pipe 14 is filled with compressed air, which creates the second pressure of about 20 psi, according to one embodiment, wherein the outlet pipe 14 is a metallic material. According to an alternate embodiment, the second pressure is about 15 psi, when the outlet pipe 14 is made of a non-metallic material, and the fire suppression system 10,110 is a pneumatic fire suppression system. The second pressure in the outlet pipe 14 can be any predetermined pressure, but it should be appreciated by those skilled in the art that the second pressure is adequate to make the actuator 17 actuate as a function of the second pressure. According to one embodiment, the actuator 17 can be actuated when the pressure in the outlet pipe 14 is altered from a set point by less than sixty percent (60%), and more specifically, when the pressure in the outlet pipe 14 is altered by less than thirty percent (30%).

By way of explanation and not limitation, the sprinkler heads 22 are any type of suitable sprinkler head 22. According to one embodiment, the sprinkler head 22 has a melting seal, and thus, as the heat around the sprinkler head 22 increases the melting seal of the sprinkler head 22 melts which opens the sprinkler head 22 and allows the gaseous fluid to enter or exit the outlet pipe 14 and branches 20, depending upon whether the fire suppression system 10 is a pneumatic or vacuum system. The melting seal may not completely disintegrate, but will at least partially melt, reshape, reduce in size, the like, or a combination thereof, in order to form an opening in the sprinkler head 22. When the gaseous fluid enters or exits the outlet pipe 14, the second pressure is altered to a pressure level that causes the valve assembly 16 to actuate and open. Thus, the valve 19 opens when the second pressure is no longer adequate to overcome the spring 46 tension of the actuator 17 when the fire suppression system 10,110 is a pneumatic system, such that the valve 19 then opens, according to one embodiment. According to an alternate embodiment, when the fire suppression system 10,110 is a vacuum system, the valve 19 opens when the second pressure is adequate to overcome the spring 46 tension of the actuator 17. Thus, the valve 19 can be a mechanically actuated ball valve that “fails open” (i.e., pneumatic system or vacuum system). The fluid is then dispensed from the sprinkler heads 22 onto the fire or heat source that melted the seal of the sprinkler heads 22.

For purposes of explanation and not limitation, the inlet pipe 12 enters the dwelling 50, and immediately connects to the valve assembly 16 and outlet pipe 14, according to one embodiment. Therefore, the vast majority of the fire suppression system 10,110 in the dwelling comprises the outlet pipe 14, which is dry, since it does not contain any fluid substance unless the fluid substance is being discharged through the sprinkler heads 22. Alternatively, the valve assembly 16 is located in a different location in the fire suppression system 10 so that only a portion of zone(s) of the system 10,110 are dry.

Typically, one having ordinary skill in the art would understand the valve assembly 16 is a non-differential valve assembly. Thus, a single source input (e.g., a pressure) can be used for valve modulation, such that the valve modulation is independent of inlet pressures (e.g., an inlet water pressure). Typical proper operation of the non-differential valve assembly 16 can be fail-to-open without needing a differential or ratio (e.g., without a pressure differential or ratio in pressure).

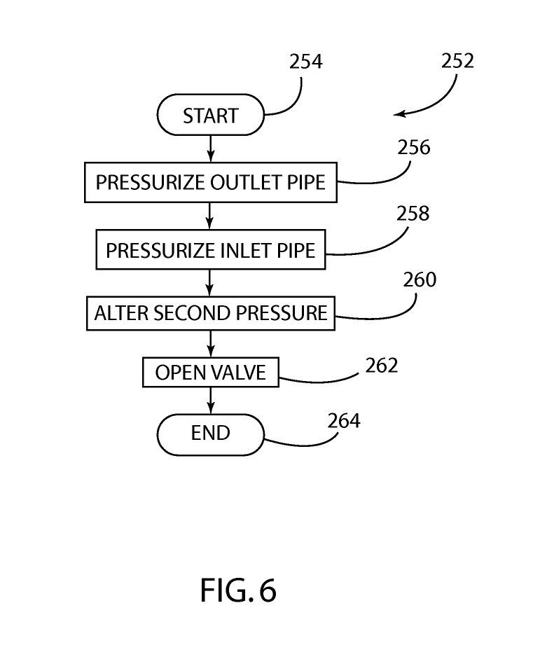

With regards to FIG. 6, a method of suppressing a fire is generally shown at reference identifier 252. The method 252 starts at step 254, and proceeds to step 256, wherein the outlet pipe 14 is pressurized. At step 258, the inlet pipe 12 is pressurized. Typically, the inlet pipe 12 is pressurized to the first pressure, wherein a fluid substance is in the inlet pipe 12 and creates the first pressure, according to one embodiment. According to one embodiment, the fire suppression system 10,110 is a pneumatic system, and the outlet pipe 14 is filled with the gaseous fluid, such as, but not limited to, compressed air, to obtain the second pressure. According to an alternate embodiment, the fire suppression system 10,110 is a vacuum system, and the gaseous fluid contained within the outlet pipe 14 substantially creates a vacuum to obtain the second pressure.

The method 252 then proceeds to step 260, wherein the second pressure is altered. According to one embodiment, the second pressure is altered by the outlet pipe 14, the branches 20, or a combination thereof, defining the opening, which allows the gaseous fluid to enter or exit the outlet pipe 14 to alter the second pressure. According to one embodiment, the sprinkler head 22 defines the opening. At step 262, the valve assembly 16 is open. According to one embodiment, wherein the fire suppression system 10,110 is a pneumatic system, the gaseous fluid exits the outlet pipe 14, such that the second pressure is no longer adequate to overcome the spring 46 tension to bias the piston 48 in a closed position, and the valve 19 is opened. According to an alternate embodiment, wherein the fire suppression system 10,110 is a vacuum system, the gaseous fluid enters the outlet pipe 14, and the second pressure is adequate to overcome the spring 46 tension and bias the piston 48 to open the valve 19. The method 252 then ends at step 264.

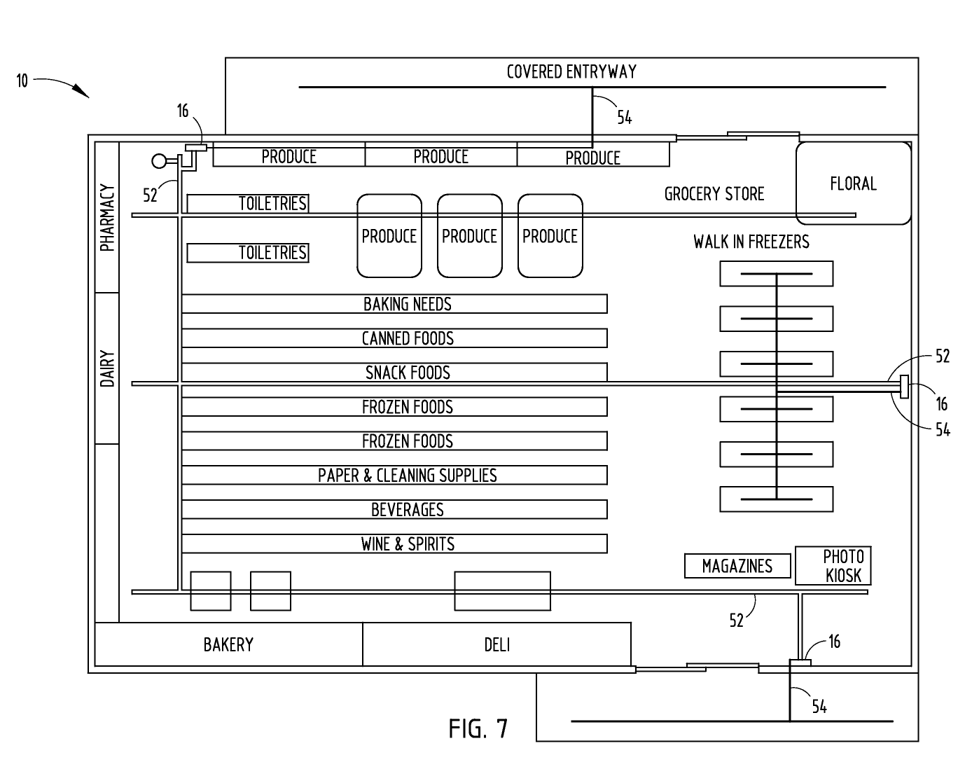

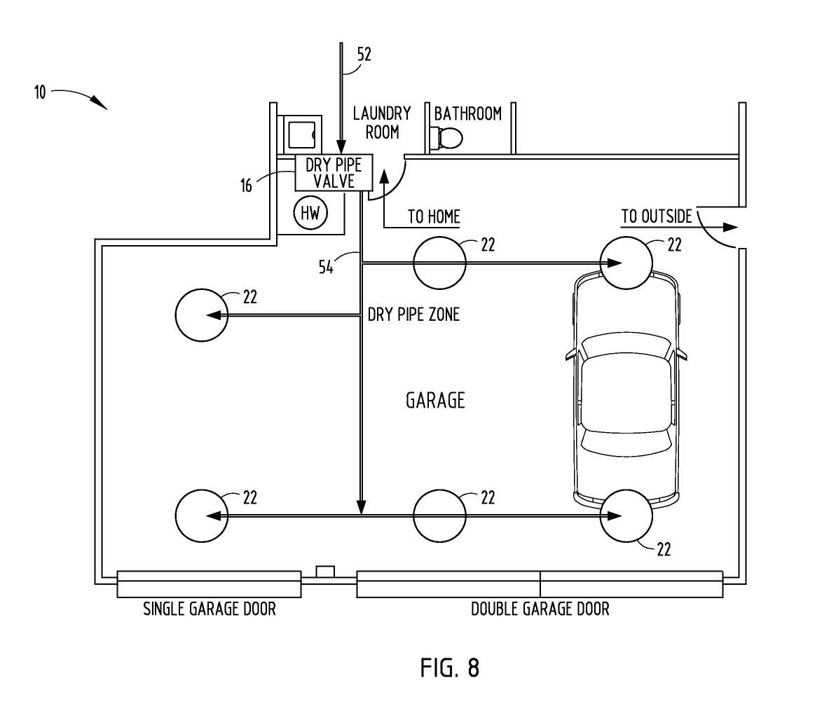

With respect to FIGS. 7 and 8, the fire suppression system 10 can have a wet portion 52 that is downstream of the inlet pipe 12 and a dry portion 54 that is upstream of the outlet pipe 14. An interior portion of a dwelling 50 can be a wet fire suppression system since the heating of the dwelling 50 will prevent the fluid in the pipes from freezing, while an exterior portion of the fire suppression system 10 that is outside the dwelling 50 can be a dry pipe portion. Thus, the valve 16 can be at a junction of the wet portion 52 and the dry portion 54, while a valve at the water main to the dwelling 50 can be a standard valve. Therefore, the entire dwelling 50 does not need to be a dry pipe system and the fire suppression system 10 can be separated into dry and wet zones.

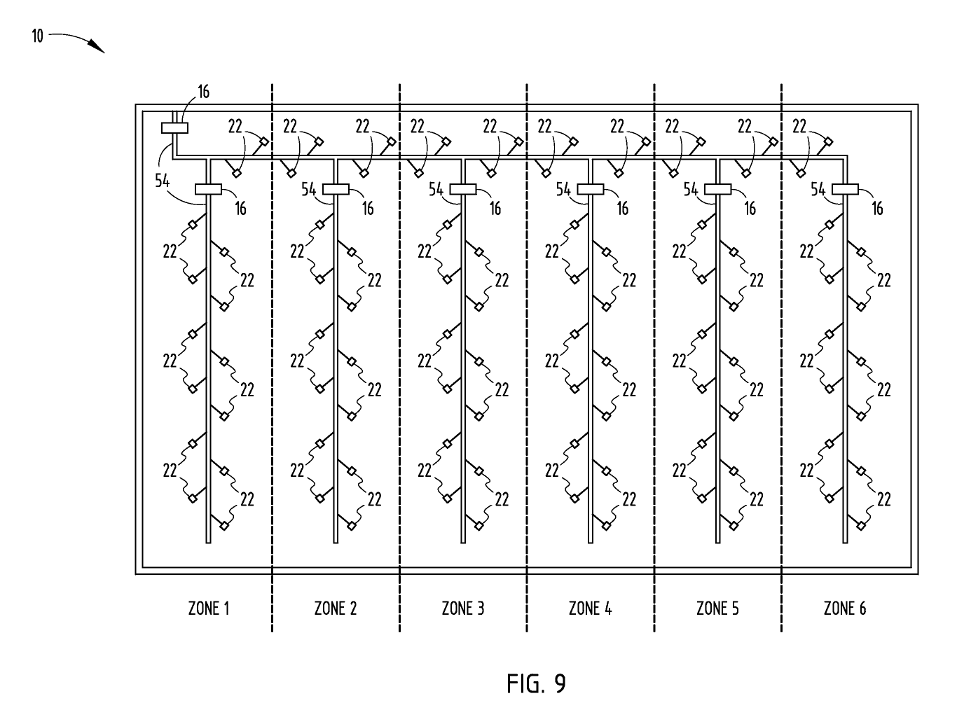

As to FIG. 9, the fire suppression system 10 can be broken into different zones, wherein each zone is a dry pipe zone, and the main valve is a dry pipe valve 16 along with the valve at each zone also being a dry pipe valve 16. Typically, such an arrangement is used in large facilities, wherein the amount of time it would take to reduce the air pressure to open the main valve 16 and fill the fire suppression system 10 with water to flow out of the sprinkler heads 22 in all the branches 20 would take an inadequately long amount of time. Thus, each branch designated as a zone can have a valve 16 so that if a fire is in one zone, the air from the other zones does not have to be removed from the fire suppression system 10 and those branches do not need to be filled with water before water begins flowing out of the sprinkler heads 22 in the zone with the fire.

For purposes of explanation and not limitation, if a fire is present in zone 6, only the sprinkler heads in zone 6 will open so that the main valve 16 and the valve 16 at the start of zone 6 will open based upon the air exiting the outlet pipes 14 in zone 6, and only this portion of the fire suppression system 10 fills up with water. Thus, zones 1-5 remain filled with air and do not need to be filled with water prior to the water exiting the sprinkler heads 22 of zone 6.

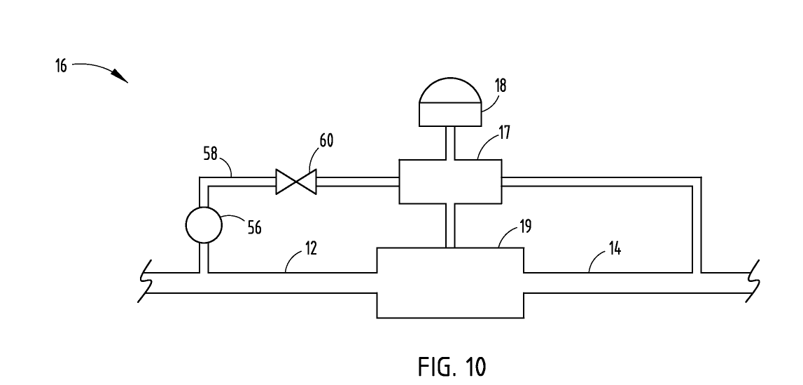

As to FIG. 10, the non-differential dry pipe valve 16 can be configured for use in the fire suppression system 10 and can include the inlet 12 at least partially filled with a fluid substance, wherein the fluid substance creates the first pressure, and the outlet 14 in fluid communication with the inlet 12, wherein the outlet 14 is filled with the gaseous fluid. The non-differential dry pipe valve 16 can further include a valve 19 in fluid communication between the inlet 12 and the outlet 14, and an actuator 17 in operable communication with the valve 19, wherein the actuator 17 is configured to open and close the valve 19. A pressure regulator 56 can be in fluid communication between the inlet 12 and the outlet 14, wherein the pressure regulator 56 can be configured to reduce a pressure of the fluid flowing from the inlet 12 to the outlet 14 through a bypass 58. A restricting valve 60 can be in fluid communication between the pressure regulator 56 and the outlet 14 along the bypass 58. The restricting valve 60 can be configured to prevent flow of the fluid from the outlet 14 to the inlet 12, such that the fluid flowing from the inlet 12 to the outlet 14 through the pressure regulator 56 and the restricting valve 60 create a second pressure to alter the actuator 17 to place the valve 19 in a closed position independent of a pressure of the gaseous fluid in the outlet 14. In such an embodiment, at least part of the dry pipe portion of the fire suppression system 10 does not have to be charged (e.g., pressurized) for the non-differential dry pipe valve 16 to be closed.

An example of flow control can be the removal or installation of one or all of the springs 46 in the valve 16, which can result in a modification of air pressure needed to open and close the ball valve 19 connected to the actuator 17. In fire suppression piping systems 10 using non-metallic pipe, such as, but not limited to, cpvc, the pressure should be maintained at or under 15 psi on the dry pipe portion 54. To achieve this, some of the springs 46 can be removed within the actuator 17. During operation of the system 10, (post trip) the flow of fluid may cause a pressure rise in the system 10. This pressure may cause a modulation in the actuator pistons 48 which may cause the ball valve 19 to close, partially open, or modulate. This can be a desirable result as a flow control application to reduce or eliminate the possibility of over pressurization of the downstream piping by the entry of water into the piping system. Thus, the actuator 17 can reclose the ball valve 19, either partially or fully to stop the admittance of additional pressure in order to maintain equilibrium at the preset set point (e.g., 15 psi).

Another exemplary benefit to this flow control operation is to maintain flow control of water to the system 10 in the event the system 10 is or becomes breached. For purposes of explanation and not limitation, a homeowner hanging a picture on the wall runs a screw into the system 10. The system 10 will begin to lose air pressure which will ultimately cause the valve 16 to modulate open. The water pressure will slowly enter the system 10 and reclose the valve 16. The cycle will be repeated until system equilibrium is reached and water will exit the breach in the system 10. This is a desirable result to prevent flooding, or over pressurization of the system 10.

Yet another example is where the dwelling 50 has cpvc installed in 90 percent of their common area prior to the job being stopped. They have several problems to address, such as, the glycol system being large and expensive to fill, the glycol fill on one end of the system traps air in the cpvc which causes a hydrostatic pressure buildup of as much as six times the inlet water pressure when the water is turned on, this air pressure far exceeds the 15 psi limit per code for cpvc pipe, bleeding the system can be difficult and the system can constantly try to fill with water at the most critical points, where the main 4″ feed is buried 2′ below grade and any water will dilute the glycol to an unknown amount with enough ambiguity to support the purge of the system to ensure glycol safe limits, when a tap is made, the water can try to fill the system and, again, is an unknown, the failure of the backflow device required for glycol systems can cause the (RPZ) to dump consequently being refilled with water, system piping can be large and combines the laws of NFPA 13 for the common areas, and NFPA 13R for the individual units, and fluid delivery time can be a question.

According to one embodiment, the valve 16 can be closed with a second pressure. This does not always mean air pressure. The cold common areas can be filled with glycol and bled backwards to the closed shut off valve through the drain in the system 10. The glycol can then be pressurized to 50 to 60 psi, enough pressure to close the dry valve 16. Though cpvc, the main is full of liquid and can withstand 175 psi and normally operates at nearly 100 psi. This closure of the dry valve 16 and the typical installation of the transducer 40 can keep water out of the system 10 and minimize or eliminate the chance for a false fill. The transducer 40 can notify all parties that there is a drop in pressure on the downstream side 54 of the dry valve 16 and give the parties time to respond prior to a false fill.

With regards to FIGS. 2-4, the fire suppression system 10 can be a pre-action system, such that the valve 16 is a deluge or a pre-action device. In such an embodiment, the actuator 17, the ball valve 19, and the limit switch 18 (e.g., the valve 16) are actuated by the inlet 12 where initial pressure is established through a pressure fill port under a transducer 40, and thus, closing the valve 16. Typically, the pressure on the outlet 14 is reduced. An electric solenoid or exhaust valve can be wired to a sensor, such as, but not limited to, a heat sensor, which can have a set point to achieve valve 16 actuation as a result of a fire. Thus, a series of conditions must be met in order for the valve 16 to actuate to an open position.

The sequence of operations can be, wherein the heat sensor is activated and opens the solenoid, and a pressure on the inlet 12 is exhausted into the outlet 14 or atmosphere. Springs in the actuator 17 actuate the valve 19 as pressure is exhausted from the inlet 12. The alarm system 24 can signal and suppression pressure flows from the inlet 12 through the valve 16 to the outlet 14. The pressure of flow from the inlet 12 to the outlet 14 can be controlled by a modulation of the valve 16, and thus, protecting the piping along the outlet 14 portion of the fire suppression system 10. As sprinkler heads 22 begin to fuse and open, the pressure is released through the open sprinkler heads 22. Suppression material then suppresses the fire.

According to one embodiment, a fill board can be added adjacent to an existing fill port in the actuator 17. Further, a piston 48 can be removed and rotated approximately 180° and re-installed from that shown in FIG. 4. Such orientation can reduce modulation of the device during the use of a low closure pressure or excessive flow pressure, and thus, allows the springs 46 to be removed for low pressure closures. Thus, the valve 16 can be used for non-metallic piping systems. In other words, the pistons 48 when rotated approximately 180° can substantially cover a center area inlet chamber when fully relaxed open (e.g., the springs 48 are extended). Flat slides can be used to provide a positive seal of the air inlet blocking the flow of pressure to the center chamber post trip. A second fill port can be adjacent to the existing fill port (e.g., on the other side clear of the friction slide) in order to reclose the device for a field setting.

Advantageously, the fire suppression system 10,110 and method 252 thereof is a dry valve system so that a portion of the system 10,110 does not contain a fluid substance when under normal operating conditions and the valve assembly 16 is in a fully closed position. Thus, the fire suppression system 10,110 can be used in uncontrolled climates where freezing temperatures, extreme heat temperatures, and extreme temperature fluctuations are reached. Additionally, when the fire suppression system 10,110 is actuated, such that the valve assembly 16 is to be opened, the actuator 17 can be actuated to open the valve assembly 16 quickly, since the actuator 17 can be actuated with a less than sixty percent (60%) change in the pressure in the outlet pipe 14. It should be appreciated by those skilled in the art that there can be other advantages of the fire suppression system 10,110 and method thereof.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A fire suppression system comprising:
at least one inlet pipe at least partially filled with a fluid substance, wherein said fluid substance creates a first pressure in said at least one inlet pipe;
at least one outlet pipe in fluid communication with said at least one inlet pipe and contains a gaseous fluid, wherein said gaseous fluid creates a second pressure in said at least one outlet pipe; and
a first valve assembly in fluid communication between said at least one inlet pipe and said at least one outlet pipe, wherein said fluid substance enters said at least one outlet pipe through said valve assembly when said second pressure is altered to a predetermined pressure.

2. The fire suppression system of claim 1, wherein said first valve assembly is a direct-acting actuated dry valve.

3. The fire suppression system of claim 1, wherein said first valve assembly is a non-differential valve assembly.

4. The fire suppression system of claim 1, wherein said at least one inlet pipe portion of the fire suppression system is a wet pipe fire suppression system and said at least one outlet pipe portion of the fire suppression system is a dry pipe fire suppression system.

5. The fire suppression system of claim 1, wherein said first valve assembly actuates, such that said fluid substance flows from said at least one inlet pipe to said at least one outlet pipe when said second pressure is altered by less than sixty percent (60%).

6. The fire suppression system of claim 1 further comprising an alarm, wherein said alarm is activated when at least one of said first pressure and said second pressure is at a predetermined pressure.

7. The fire suppression system of claim 1 further comprising a second valve assembly in fluid communication along said at least one outlet pipe between said first valve assembly and a first sprinkler zone and a third valve assembly in fluid communication along said at least one outlet pipe between said first valve assembly and a second sprinkler zone.

8. The fire suppression system of claim 7, wherein said second and third valve assemblies are non-differential valve assemblies.

9. A fire suppression system comprising:
at least one inlet pipe at least partially filled with a fluid substance, wherein said fluid creates a first pressure in said at least one inlet pipe;
at least one outlet pipe in fluid communication with said at least one inlet pipe and contains a gaseous fluid, wherein said gaseous fluid creates a second pressure in said at least one outlet pipe, and said at least one outlet pipe defines at least one opening; and
a first non-differential dry valve assembly in fluid communication between said at least one inlet pipe and said at least one outlet pipe, wherein said fluid substance enters said at least one outlet pipe through said first non-differential dry valve assembly when said second pressure is altered to a predetermined pressure, and said fluid substance exits said at least one outlet pipe through said at least one opening.

10. The fire suppression system of claim 9, wherein said at least one inlet pipe portion of the fire suppression system is a wet pipe fire suppression system and said at least one outlet pipe portion of the fire suppression system is a dry pipe fire suppression system.

11. The fire suppression system of claim 9 further comprising an alarm, wherein said alarm is activated when said second pressure is at a predetermined pressure.

12. The fire suppression system of claim 9 further comprising a second valve assembly in fluid communication along said at least one outlet pipe between said first valve assembly and a first sprinkler zone and a third valve assembly in fluid communication along said at least one outlet pipe between said first valve assembly and a second sprinkler zone.

13. The fire suppression system of 9, wherein said non-differential dry valve assembly comprises a mechanically actuated ball valve.

14. A non-differential dry pipe valve configured for use in a fire suppression system, said non-differential dry pipe valve comprising:
an inlet at least partially filled with a fluid substance, wherein said fluid substance creates a first pressure;
an outlet in fluid communication with said inlet, wherein said outlet is filled with a gaseous fluid;
a valve in fluid communication between said inlet and said outlet;
an actuator in operable communication with said valve, wherein said actuator is configured to open and close said valve;
a pressure regulator in fluid communication between said inlet and said outlet, wherein said pressure regulator is configured to reduce a pressure of said fluid flowing from said inlet to said outlet; and
a restricting valve in fluid communication between said pressure regulator and said outlet, wherein said restricting valve is configured to prevent flow of said fluid from said outlet to said inlet, such that said fluid flowing from said inlet to said outlet through said pressure regulator and said restricting valve create a second pressure to alter said actuator to place said valve in a closed position independent of a pressure of said gaseous fluid in said outlet.

15. The non-differential dry pipe valve claim 14, wherein said pressure regulator is configured to regulate said pressure of said fluid flowing from said inlet to said outlet to approximately 15 pounds per square inch (psi).

16. The non-differential dry pipe valve claim 14 is an intermediate valve in the fire suppression system, such that the valve separates a wet pipe portion of the fire suppression system and a dry pipe portion of the fire suppression system.

17. The non-differential dry pipe valve claim 14 in fluid communication with a second non-differential dry pipe valve in the fire suppression system.

18. The non-differential dry pipe valve claim 14, wherein said actuator comprises:
at least one spring having a tension; and
at least one piston that is biased towards a closed position by said spring tension, wherein when said valve assembly is in a closed position, said second pressure is inadequate to overcome said spring tension so said at least one piston is in said closed position, and when said valve assembly is in an open position, said second pressure is adequate to overcome said spring tension so said at least one piston is in an open position.

19. The non-differential dry pipe valve claim 14, wherein the fire suppression system is a pneumatic actuated dry valve fire suppression system.

20. The non-differential dry pipe valve claim 14 being a main valve of the fire suppression system.
